(19) United States
(12) Patent Application Publication
(10) Pub. No.: US 2021/0367321 A1
(43) Pub. Date: Nov. 25, 2021

(54) SLOT ANTENNAS HAVING PARASITIC ELEMENTS

(71) Applicant: Hewlett-Packard Development Company, L.P., Spring, TX (US)

(72) Inventors: Chen-Ta Hung, Taipei City (TW); Chi- Ting Hsu, Taipei City (TW); Ming- Shien Tsai, Taipei City (TW)

(73) Assignee: Hewlett-Packard Development Company, L.P., Spring, TX (US)

(21) Appl. No.: 16/978,730

(22) PCT Filed: Jul. 10, 2018
(86) PCT No.: PCT/US2018/041348

§ 371 Date: Sep. 7, 2020

(51) Int. Cl. H01Q 1/22; H01Q 13/10; H01Q 5/385

(52) U.S. Cl. CPC H01Q 1/2266; H01Q 13/10; H01Q 1/48; H01Q 5/385; H01Q 1/2283

(57) ABSTRACT

In one example, a slot antenna may include a ground plane defining a slot, an antenna cavity formed on the ground plane corresponding to the slot, an antenna printed circuit board (PCB) disposed on the antenna cavity, a first parasitic element and a second parasitic element disposed on the antenna PCB, and a feeding element formed on the second parasitic element. The feeding element may induce magnetic resonance and electric resonance for multiple frequency bands.

### BACKGROUND

Portable electronic devices are becoming increasingly popular. Examples of portable electronic devices may include handheld computers (e.g., notebooks, tablets, and the like), cellular telephones, media players, and hybrid devices which include the functionality of multiple devices of this type. Due in part to their mobile nature, such electronic devices may often be provided with wireless communications capabilities, which may rely on antenna technology to radiate radio frequency (RF) signals for transmission as well as to gather RF broadcast signals for reception.

### BRIEF DESCRIPTION OF THE DRAWINGS

Examples are described in the following detailed description and in reference to the drawings, in which:

FIG. 1 is a schematic view of an example slot antenna including multiple parasitic elements disposed on a printed circuit board (PCB);

FIG. 2A is a schematic view of an example antenna structure including a radiating magnetic antenna element, a radiating electrical antenna element, and a radio frequency (RF) tuner;

FIG. 2B is a schematic view of the example antenna structure of FIG. 2A, depicting additional features;

FIG. 3A is a schematic diagram of the example antenna structure of FIG. 2B, depicting coupling of electromagnetic energy to a slot to induce a magnetic resonance in a low frequency band;

FIG. 3B is a schematic diagram of the example antenna structure of FIG. 2B, depicting coupling of electric current to a second parasitic element to induce an electric resonance in a high frequency band;

FIG. 4A is a perspective view of an example electronic device, depicting an antenna structure corresponding to a closed slot in a metal housing; and

FIG. 4B is a perspective view of the example electronic device of FIG. 4A, depicting additional features.

### DETAILED DESCRIPTION

Electronic devices such as mobile phones, notebooks, tablets, personal digital assistants (PDAs), or the like may have wireless communications capabilities. Such electronic devices may wirelessly communicate with a communications infrastructure to enable the consumption of digital media content. In order to wirelessly communicate with other devices, the electronic devices may be provided with antennas. To satisfy consumer demand for small form factor wireless devices, manufacturers may be continually trying to implement wireless communications circuitry such as antenna components using compact structures. At the same time, wireless devices may have to cover a growing number of communications bands. The antennas and wireless circuitry in such electronic devices may have to cover a range of operating frequencies.

In some examples, electronic devices may have a metal cover including a plastic antenna window (i.e., toenail window) attached at the top of the metal cover for enhancing antenna radiation performance. In such electronic devices, a linkage portion may be formed between the plastic antenna window and the metal cover. Therefore, such metal covers may involve significant manufacture efforts, strength issues, and dis-color or shadow issues at the linkage portion.

In other examples, electronic devices may use an open slot antenna, in which a plastic antenna lid is attached by insert molding the antenna lid to an open slot of the metal cover. However, insert molding plastic into the open slot may involve significant manufacture cost and complexity, and may have a degraded antenna performance due to insufficient bandwidth.

In other examples, electronic devices may use a closed slot antenna. In this example, a closed slot on the metal cover may be formed by stamping metal, and computer numerical control (CNC) machining the required slot dimension. The process to form the closed slot may be easy and involve low cost. However, the closed slot may have a drawback of narrow resonant bandwidth at a low-frequency band and may occupy double size space when compared to the open slot, i.e., % wavelength guide for open slot vs. % wavelength guide for closed slot.

Examples described herein may provide hybrid antennas with a closed slot for multi-band frequencies such as Long-Term Evolution (LTE) frequency bands and/or fifth generation (5G) frequency bands (e.g., sub-6 GHz). In hybrid antennas, one resonance may come from a magnetic resonance, while the other resonance may come from an electric resonance.

In the following description, for purposes of explanation, numerous specific details are set forth in order to provide a thorough understanding of the present techniques. It will be apparent, however, to one skilled in the art that the present apparatus, devices and systems may be practiced without these specific details. Reference in the specification to “an example” or similar language means that a particular feature, structure, or characteristic described is included in at least that one example, but not necessarily in other examples.

Examples described herein may provide an antenna structure for an electronic device. The antenna structure may include a ground plane (e.g., a metal housing of the electronic device) defining a cavity-backed slot antenna, an antenna printed circuit board (PCB) mounted on the cavity-backed slot antenna, a first parasitic element and a second parasitic element disposed on the antenna PCB, and a feeding element formed on the second parasitic element. The feeding element may couple electromagnetic energy to the cavity-backed slot antenna to induce the magnetic resonance in a low frequency band and couple electric current to the second parasitic element to induce the electric resonance in a high frequency band.

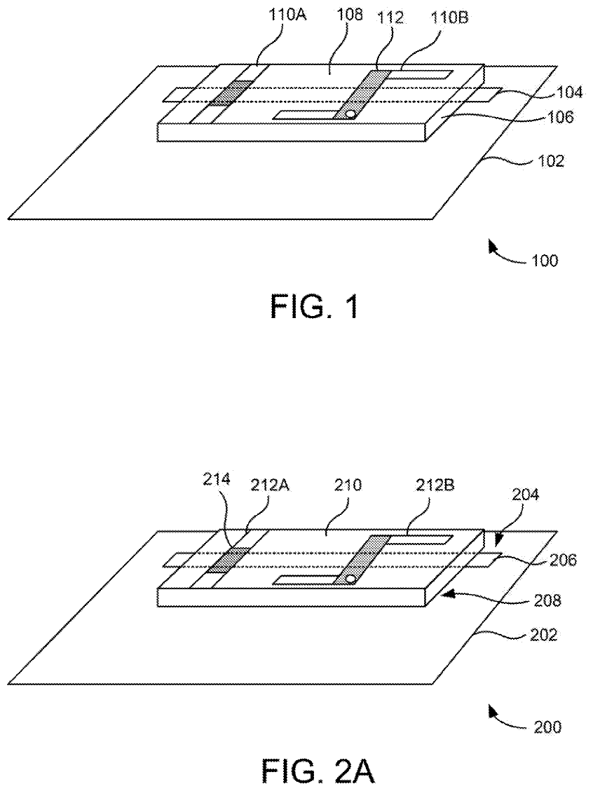

Turning now to the figures, FIG. 1 is a schematic view of an example slot antenna 100 including multiple parasitic elements (e.g., parasitic elements 110A and 110B) disposed on an antenna PCB 108. Slot antenna 100 may be used in an electronic device such as a cellular phone, a notebook, a tablet, a personal computer (PC), a personal digital assistant, or any other device having wireless connectivity capability.

Slot antenna 100 may include a ground plane 102 defining a slot 104. In one example, slot 104 that is defined in ground plane 102 may form a slot antenna element. Example slot 104 may be a closed slot with opposite width and length sides closed within ground plane 102. In other examples, slot 104 may be an elongated slot.

Further, slot antenna 100 may include an antenna cavity 106 formed on ground plane 102 corresponding to slot 104. In one example, antenna cavity 106 may be formed beneath slot 104. Furthermore, slot antenna 100 may include antenna PCB 108 disposed on antenna cavity 106. Example antenna PCB 108 may be a multi-layered PCB. In another example, antenna cavity 106 may be a hollow cavity formed in antenna PCB 108 underneath slot 104. Slot 104 may be capacitively fed by antenna cavity 106. In this example, connection points for slot 104 may be provided indirectly to slot 104 via antenna cavity 106.

Furthermore, slot antenna 100 may include a first parasitic element 110A and a second parasitic element 110B disposed on antenna PCB 108. In one example, first parasitic element 110A may be spaced apart from second parasitic element 110B on a surface of antenna PCB 108. In other words, first parasitic element 110A may be disengaged with second parasitic element 110B.

Also, slot antenna 100 may include a feeding element 112 formed on second parasitic element 110B to induce magnetic resonance and electric resonance for multiple frequency bands. In some examples, feeding element 112 may be formed across slot 104 and electrically connected to a feeding point. For example, feeding element 112 may couple antenna PCB 108 with ground plane 102.

In one example, feeding element 112 may couple electromagnetic energy to slot 104 via antenna cavity 106 to induce the magnetic resonance in a low frequency band. In another example, feeding element 112 may couple electric current to second parasitic element 1108 to induce the electric resonance in a high frequency band. For example, the low frequency band may correspond to a range of 699 to 960 MHz and the high frequency band may correspond to a range of 1710 MHz to 5900 MHz.

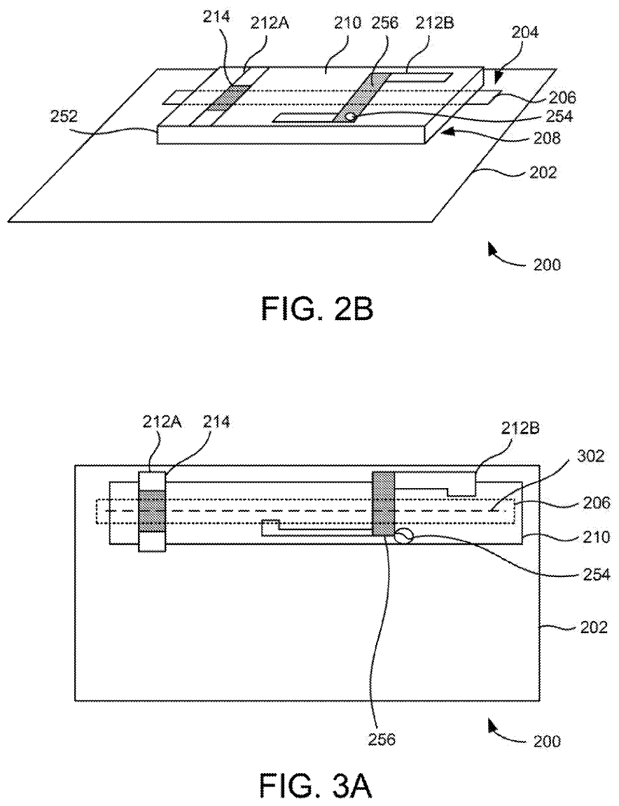

FIG. 2A is a schematic view of an example antenna structure 200 including a radiating magnetic antenna element 204, a radiating electrical antenna element 208, and a radio frequency (RF) tuner 214. Antenna structure 200 may be disposed in an interior of an electronic device, i.e., inside a metal housing of the electronic device. Antenna structure 200 may include a ground plane 202. Example ground plane 202 may be formed using the metal housing of the electronic device.

Further, antenna structure 200 may include radiating magnetic antenna element 204 formed as a slot 206 in ground plane 202. Example radiating magnetic antenna element 204 may be a cavity-backed slot antenna. During operation, radiating magnetic antenna element 204 may resonate at a first resonant frequency. In this example, electromagnetic energy may be indirectly fed to the cavity-backed slot antenna to induce a magnetic resonance to allow the cavity-backed slot antenna to resonate at the first resonant frequency in a low-frequency band.

Furthermore, antenna structure 200 may include radiating electrical antenna element 208 provided in a plane arranged at a distance from and parallel to ground plane 202. Radiating electrical antenna element 208 may be disposed at a distance from and parallel to ground plane 202 via an antenna cavity. In one example, radiating electrical antenna element 208 may include an antenna PCB 210. Further, radiating electrical antenna element 208 may include a first parasitic element 212A and a second parasitic element 212B mounted on antenna PCB 210 to resonate at a second resonant frequency. In one example, the second resonant frequency is greater than the first resonant frequency. In this example, electric current may be directly fed to second parasitic element 2128 to induce an electric resonance to allow second parasitic element 212B to resonate at the second resonant frequency in a mid-frequency band or a high-frequency band.

Furthermore, antenna structure 200 may include RF tuner 214 disposed on first parasitic element 212A to tune the first resonant frequency. In one example, RF tuner 214 may be coupled across slot 206 at a surface of first parasitic element 212A to compensate a length of slot 206 to flexibly adjust the first resonant frequency. In some examples, first parasitic element 212A may control the low-frequency band and may include natural resonant frequency with 2^{nd} and 3^{rd} harmonic behavior, which can contribute energy on LTE band (e.g., 1800/2700 MHz) performance.

FIG. 2B is a schematic view of example antenna structure 200 of FIG. 2A, depicting additional features. For example, similarly named elements of FIG. 2B may be similar in structure and/or function to elements described with respect to FIG. 2A. As shown in FIG. 2B, radiating electrical antenna element 208 may be disposed on the antenna cavity or the cavity-backed slot antenna via a cavity holder 252. Example cavity holder 252 may be formed of a dielectric material such as a plastic substrate, a foam substrate, a ceramic substrate, a glass substrate, a polymer substrate, or any other desired dielectric substrate.

Further as shown in FIG. 2B, antenna structure 200 may include a feeding point 254 and a feeding element 256 formed on second parasitic element 212B and electrically connected to feeding point 254. For example, feeding point 254 may be a physical connection that carries the RF signals to and/or from the antenna structure 200 and an RF circuitry of the electronic device. In other examples, the RF circuitry may transmit and/or receive the RF signals to/from radiating electrical antenna element 208 and radiating magnetic antenna element 204 via feeding point 254. In these examples, feeding point 254 may be electrically coupled to an RF short circuit.

Further, feeding element 256 may couple antenna PCB 210 with ground plane 202. In one example, feeding point 254 may be connected to a location on antenna structure 200 to cause antenna structure 200 to resonate at the first resonant frequency or the second resonant frequency. As shown in FIG. 2B, feeding element 256 may be formed as a part of second parasitic element 212B and directly connected to feeding point 254.

In one example, feeding element 256 may couple electromagnetic energy to slot 206 via the antenna cavity to induce a magnetic resonance in the low-frequency band. In another example, feeding element 256 may couple electric current to second parasitic element 212B to induce an electric resonance in the mid-frequency or high-frequency band.

For example, the low-frequency band may start from 699 MHz, the mid-frequency band may be between 1710-2690 MHz, and the high-frequency band may be greater than 3400 MHz. The antenna structure may not be limited to these example frequency bands. Further, different frequencies in the low-frequency band can be tuned by RF tuner 214 by compensating the length of slot 206. The example antenna structure 200 can apply to an LTE system, 5G system (e.g., sub-6 GHz), or any other system requiring the frequency bands as generated by antenna structure 200.

In some examples, disposing radiating electrical antenna element 208 on top of radiating magnetic antenna element 204 may be advantageous. For example, with this orientation of the electrical antenna element 208 and radiating magnetic antenna element 204 in relation to each other, electrical antenna element 208 and radiating magnetic antenna element 204 can be used simultaneously and thus antenna diversity can be obtained. In another example, the orientation of the electrical antenna element 208 and radiating magnetic antenna element 204 in relation to each other may provide a small sized antenna arrangement (e.g., that may occupy a space provided for a single antenna) that can be disposed inside an electronic device and can have good antenna properties for a wide frequency range.

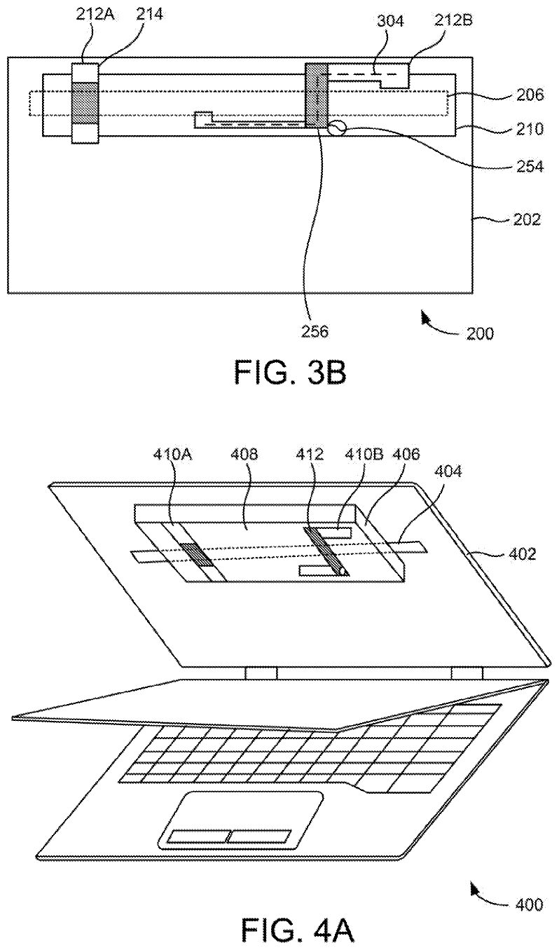

FIG. 3A is a schematic diagram of example antenna structure 200 of FIG. 2B, depicting coupling of electromagnetic energy to slot 206 to induce a magnetic resonance in a low frequency band. For example, similarly named elements of FIG. 3A may be similar in structure and/or function to elements described with respect to FIG. 2B. As shown in FIG. 3A, energy may be indirectly coupled to slot 206 via the antenna cavity to induce magnetic resonance (e.g., as shown by dotted line 302) for the low-frequency band. Further, the magnetic resonance can be modified to enhance bandwidth of the low-frequency band by shunting different capacitance to change a magnetic field associated with slot 206.

FIG. 3B is a schematic diagram of example antenna structure 200 of FIG. 2B, depicting coupling of electric current to second parasitic element 2128 to induce an electric resonance in a high frequency band. For example, similarly named elements of FIG. 3B may be similar in structure and/or function to elements described with respect to FIG. 2B. As shown in FIG. 3B, electric current may be directly coupled to second parasitic element 212B to induce the electric resonance (e.g., as shown by dotted line 304) for the mid-frequency or the high-frequency band.

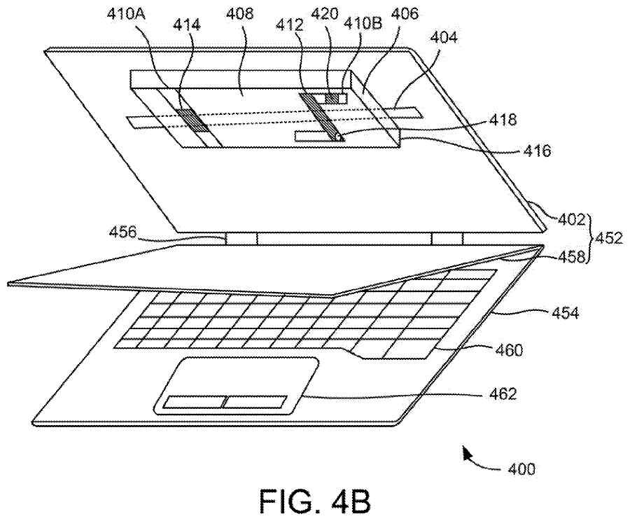

FIG. 4A is a perspective view of an example electronic device 400, depicting an antenna structure corresponding to a closed slot 404 in a metal housing 402. FIG. 4B is a perspective view of example electronic device 400 of FIG. 4A, depicting additional features. Electronic device 400 may be a content rendering device that includes a wireless modem for connecting electronic device 400 to a network.

Example electronic device 400 may include a tablet computer, a notebook computer, an electronic book reader, a portable digital assistant, a mobile phone, a laptop computer, a portable media player, a camera, a video camera, a netbook, a desktop computer, a gaming console, a DVD player, a media center, or the like. Electronic device 400 may connect to the network to obtain content from a server (e.g., a content provider) or to perform other activities.

An example electronic device 400 such as a notebook computer or a tablet computer may be explained in FIGS. 4A and 4B. Referring to FIG. 4B, electronic device 400 may include a base portion 454 and a display portion 452 connected to base portion 454 via a hinge structure 456. Hinge structure 456 may pivotally, twistably, or detachably couple display portion 452 and base portion 454. For example, base portion 454 may include a keyboard 460, a touchpad 462, and so on. Display portion 452 may include a display 458 (e.g., a touch-screen display) and a metal housing 402 (i.e., a display cover) that can be attached to display 458.

Example display 458 may include liquid crystal display (LCD), light emitting diode (LED) display, electro-luminescent (EL) display, or the like. Also, electronic device 400 may be equipped with other components such as a camera, an audio/video device, or the like depending on the functions of electronic device 400. In some examples, display 458 and keyboard 460 can be housed in a single housing. In other examples, electronic device 400 can also be implemented without some of the components such as keyboard 460 and touchpad 462. Further, electronic device 400 may include a processor and a transceiver in communication with the processor to transmit and receive antenna signals.

As shown in FIGS. 4A and 4B, the antenna structure may be disposed in display portion 452. In other examples, the antenna structure may also be disposed in base portion 454 of electronic device 400. Referring to FIG. 4A, electronic device 400 may include metal housing 402 that forms a ground plane. Further, electronic device 400 may include closed slot 404 in metal housing 402. Closed slot 404 may be an elongated opening in metal housing 402 and may be filled with a dielectric material such as glass, ceramic, plastic, or other insulator that can allow transmission and reception of signals. In some examples, closed slot 404 may be formed in metal housing 402 by CNC machining.

In FIGS. 4A and 4B, closed slot 404 may be located between two length sides of metal housing 402. The length and width sides of closed slot 404 may be parallel to the length and width sides of metal housing 402, respectively. The term “parallel” in this disclosure may encompass substantially parallel and entirely parallel. The term “substantial” may encompass some insignificant minute amount of variation. In another example, closed slot 404 may be tilted by a certain angle with respect to the width side of an antenna PCB 408. Closed slot 404 may be a slot that is closed at both the opposite width sides of metal housing 402. Closed slot 404 may be rectangular. Further, the length of closed slot 404 may be significantly larger than the width. The length and width sides of antenna PCB 408 may be parallel to the length and width sides of closed slot 404.

Further, electronic device 400 may include an antenna cavity 406 formed on metal housing 402 corresponding to closed slot 404. Electronic device 400 may include antenna PCB 408 disposed on antenna cavity 406 via a first surface of antenna PCB 408. As shown in FIG. 4B, antenna PCB 408 may be disposed on antenna cavity 406 via a cavity holder 416.

Electronic device 400 may include a first parasitic element 410A and a second parasitic element 410B mounted on a second surface of antenna PCB 408. The second surface is opposite to the first surface. Example first parasitic element 410A and second parasitic element 410B may include metal structures. In one example, first parasitic element 410A may be spaced apart from second parasitic element 410B. Electronic device 400 may include a feeding element 412 formed on second parasitic element 410B to couple antenna PCB 408 with metal housing 402. As shown in FIG. 4B, feeding element 412 may be electrically connected to feeding point 418.

In one example, antenna PCB 408 may be interposed between parasitic elements (i.e., first parasitic element 410A and second parasitic element 410B) and antenna cavity 406, antenna cavity 406 may be formed between antenna PCB 408 and metal housing 402, parasitic elements 410A and 410B may be interposed between display 458 and antenna PCB 408.

During operation, closed slot 404 may resonate in a low-band frequency range and second parasitic element 410B may resonate in a high-band frequency range. In one example, feeding element 412 may indirectly feed electromagnetic energy to closed slot 404 via antenna cavity 406 to induce a magnetic resonance in the low-band frequency range and directly feed electric current to second parasitic element 410B to induce an electric resonance in the high-band frequency range.

As shown in FIG. 4B, electronic device 400 may include a first RF tuner 414 disposed on first parasitic element 410A. First RF tuner 414 may include a tuning element to tune frequencies corresponding to the low-band frequency range as generated via closed slot 404. In other examples as shown in FIG. 4B, electronic device 400 may include a second RF tuner 420 disposed on second parasitic element 4108. Second RF tuner 420 may include a tuning element to control/tune frequencies corresponding to the high-band frequency range as generated via second parasitic element 4108. In some examples, second RF tuner 420 may be disposed on a top portion or a bottom portion of second parasitic element 410B. In other examples, first RF tuner 414 and second RF tuner 420 can be disposed at other locations in electronic device 400 and can be connected to first parasitic element 410A and second parasitic element 410B, respectively.

Example tuning elements may include tunable inductors, tunable capacitors, or other tunable components. Tunable elements may be based on switches and networks of fixed components, distributed metal structures that produce associated distributed capacitances and inductances, variable solid-state devices for producing variable capacitance and inductance values, tunable filters, or other suitable tunable structures. First RF tuner 414 may issue control signals to adjust inductance values, capacitance values, or other parameters associated with tunable elements, thereby tuning slot antenna (i.e., closed slot 404) to cover desired communications bands in the low-band frequency range. Similarly, Second RF tuner 420 may issue control signals to adjust inductance values, capacitance values, or other parameters associated with tunable elements, thereby tuning second parasitic element 410B to cover desired communications bands in the high-band frequency range (e.g., 1710 MHz to 2700 MHz, 3300 MHz to 4400 MHz, and/or 5150 MHz to 5900 MHz).

Even though FIGS. 1-4 are explained using an antenna PCB in the antenna design, other substrates such as a glass substrate, a ceramic substrate, or a semiconductor substrate can also be used to implement the functionalities described in FIGS. 1-4. Examples described herein may provide a tunable close slot antenna that can be applicable for LTE bands. Examples described herein may support 5G LTE technology (e.g., 3.5 GHz and 5 GHz). Examples described herein may reduce manufacture cost and enhance strength of the closed slot filled with plastic. Also, the closed slot filled with plastic may have a uniform appearance on metal housing, while covering various communications bands, i.e., low-frequency and high-frequency bands.

It may be noted that the above-described examples of the present solution are for the purpose of illustration only. Although the solution has been described in conjunction with a specific implementation thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract, and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A slot antenna comprising:
a ground plane defining a slot;
an antenna cavity formed on the ground plane corresponding to the slot;
an antenna printed circuit board (PCB) disposed on the antenna cavity;
a first parasitic element and a second parasitic element disposed on the antenna PCB; and
a feeding element formed on the second parasitic element to induce magnetic resonance and electric resonance for multiple frequency bands.

2. The slot antenna of claim 1, wherein the feeding element is to couple electromagnetic energy to the slot via the antenna cavity to induce the magnetic resonance in a low-frequency band.

3. The slot antenna of claim 1, wherein the feeding element is to couple electric current to the second parasitic element to induce the electric resonance in a high-frequency band.

4. The slot antenna of claim 1, wherein the first parasitic element is spaced apart from the second parasitic element.

5. The slot antenna of claim 1, further comprising a feeding point, wherein the feeding element is to form across the slot and electrically connect to the feeding point, and wherein the feeding element is to couple the antenna PCB with the ground plane.

6. The slot antenna of claim 1, wherein the slot is a closed slot with opposite width and length sides closed within the ground plane.

7. An antenna structure comprising:
a ground plane;
a radiating magnetic antenna element formed as a slot in the ground plane, wherein the radiating magnetic antenna element is to resonate at a first resonant frequency;
a radiating electrical antenna element provided in a plane arranged at a distance from and parallel to the ground plane, wherein the radiating electrical antenna element comprises:
an antenna printed circuit board (PCB); and
a first parasitic element and a second parasitic element mounted on the antenna PCB to resonate at a second resonant frequency, wherein the second resonant frequency is greater than the first resonant frequency; and
a radio frequency (RF) tuner disposed on the first parasitic element to tune the first resonant frequency.

8. The antenna structure of claim 7, wherein the radiating magnetic antenna element is a cavity-backed slot antenna.

9. The antenna structure of claim 7, wherein the RF tuner is to couple across the slot at a surface of the first parasitic element to compensate a length of the slot to flexibly adjust the first resonant frequency.

10. The antenna structure of claim 7, further comprising:
a feeding point; and
a feeding element formed on the second parasitic element and electrically connected to the feeding point, wherein the feeding element is to couple the antenna PCB with the ground plane.

11. The antenna structure of claim 10, wherein the feeding element is to couple electromagnetic energy to the slot via an antenna cavity to induce a magnetic resonance in a low-frequency band, and wherein the feeding element is to couple electric current to the second parasitic element to induce an electric resonance in a high-frequency band.

12. An electronic device comprising:
a metal housing that forms a ground plane;
a closed slot in the metal housing;
an antenna cavity formed on the metal housing corresponding to the closed slot;
an antenna printed circuit board (PCB) disposed on the antenna cavity via a first surface of the antenna PCB;
a first parasitic element and a second parasitic element mounted on a second surface of the antenna PCB, wherein the first parasitic element is spaced apart from the second parasitic element; and
a feeding element formed on the second parasitic element to couple the antenna PCB with the metal housing, wherein the closed slot is to resonate in a low-band frequency range and wherein the second parasitic element is to resonate in a high-band frequency range.

13. The electronic device of claim 12, further comprising:
a first radio frequency (RF) tuner disposed on the first parasitic element, wherein the first RF tuner comprises a tuning element to tune frequencies corresponding to the low-band frequency range as generated via the closed slot; and
a second RF tuner disposed on the second parasitic element, wherein the second RF tuner comprises a tuning element to tune frequencies corresponding to the high-band frequency range as generated via the second parasitic element.

14. The electronic device of claim 12, wherein the feeding element is to indirectly feed electromagnetic energy to the closed slot via the antenna cavity to induce a magnetic resonance in the low-band frequency range and directly feed electric current to the second parasitic element to induce an electric resonance in the high-band frequency range.

15. The electronic device of claim 12, wherein the antenna PCB is mounted on the antenna cavity via a cavity holder, and wherein the first parasitic element and the second parasitic element comprise metal structures.
